(19) United States
(12) Patent Application Publication
(10) Pub. No.: US 2021/0179903 A1
(43) Pub. Date: Jun. 17, 2021

(54) ADHESIVE PRODUCED USING ASPARTATE-TERMINATED PREPOLYMERS

(71) Applicant: Covestro LLC, Pittsburgh, PA (US)

(72) Inventors: Raymond Zeliznik, Bradford Woods, PA (US); Karl W. Haider, Wexford, PA (US); Francis C. Rossitto, Danvers, MA (US); Philip Jones, Gibsonia, PA (US); Matthew Stewart, Pittsburgh, PA (US)

(21) Appl. No.: 16/898,901

(22) Filed: Jun. 11, 2020

Related U.S. Application Data
(60) Provisional application No. 62/946,494, filed on Dec. 11, 2019.

(51) Int. Cl. C09J 175/12; B32B 27/08; B32B 27/32; B32B 27/36; B32B 15/08; B32B 15/20; B32B 27/10

(52) U.S. Cl. CPC C09J 175/12; B32B 27/08; B32B 27/32; B32B 27/36; B32B 2250/24; B32B 15/20; B32B 27/10; B32B 2439/00; B32B 15/08

(57) ABSTRACT

Provided are adhesives comprising: (A) an aliphatic polyisocyanate; and (B) an aspartate-terminated prepolymer which is a reaction product of (B1) an aliphatic NCO-terminated prepolymer having a NCO content of from 0.5% to 35%, and (B2) a compound according to formula (I)

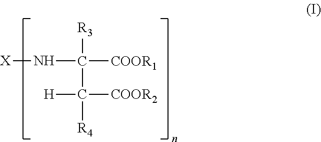

wherein, X represents a linear or branched aliphatic group obtained by removing amino groups from a linear or branched aliphatic polyamine, R₁ and R₂ are identical or different and represent organic groups which are inert towards isocyanate groups at a temperature of 100° C. or less, R₃ and R₄ are identical or different and represent hydrogen or organic groups which are inert towards isocyanate groups at a temperature of 100° C. or less, n represents an integer with a value of at least 2, wherein the aspartate-terminated prepolymer (B) has a ratio of equivalents of NH groups to equivalents of NCO groups of 1.5:1 to 20:1, (C) optionally, a solvent, wherein the adhesive has a ratio of equivalents of NCO groups in the aliphatic polyisocyanate to equivalents of NH groups of from 0.9:1 to 1.75:1, wherein pot life of the adhesive, as measured by doubling of viscosity according to ASTM D4212-16 at 23° C., is greater than or equal to 0.5 hours, and wherein the adhesive develops an acceptable bond strength to a substrate, defined as having a minimum of 150 g/in. measured @ 23° C. according to ASTM D 1876-01 or substrate tear, in less than or equal to 5 days after the substrate is laminated with the adhesive.

### CROSS REFERENCE TO RELATED APPLICATIONS

The present application claims priority under 35 U.S.C. § 119 to U.S. Provisional Patent Application Ser. No. 62/946,494, filed Dec. 11, 2019, the entire contents of which are incorporated herein by reference.

### FIELD OF THE INVENTION

The present invention relates in general to adhesives, and more specifically to adhesives produced from aspartate-terminated prepolymers and the resulting multi-layered laminated films produced using these adhesives.

### BACKGROUND OF THE INVENTION

Flexible packagings intended for the packaging of diverse products, such as those manufactured by the food processing, cosmetics or detergents industries, are usually made of several thin layers (sheets or films). The thickness of these layers is generally between 5 μm and 150 μm and may comprise several different materials, such as paper, metal (e.g., aluminum) or thermoplastic polymers. The corresponding multilayer laminate, which may have a thickness of from 20 μm to 400 μm, makes it possible to combine the properties of the different individual layers of material to provide the consumer with a combination of characteristics suitable for the final flexible packaging. Such characteristics include, but are not limited to visual appearance, a barrier effect (to atmospheric moisture or to oxygen), contact with food without risk of toxicity or of modification to the organoleptic properties of the packaged foodstuffs, chemical resistance for certain products, such as ketchup or liquid soap, and good behavior at high temperature, for example in the case of pasteurization.

In conventional multilayer flexible packaging, two component (2K) polyurethane adhesive compositions are typically used to laminate the layers. These compositions are oftentimes based on polyurethane systems that employ aromatic polyisocyanates. After the adhesive is applied and the films are laminated, the films are wound onto large rolls and are stored at elevated temperatures for several days to allow for any unreacted polyisocyanate monomer to complete curing. If this curing step is eliminated, or is of insufficient length, the laminates may suffer from two problems: first, the mechanical strength of the adhesive bond may not be sufficient for further handling and use of the laminated packaging film; and second, unreacted monomeric aromatic polyisocyanates can react with moisture in the product to be packaged, generating monomeric aromatic polyamines, which may migrate into the contents of the package. This is particularly problematic in high performance packaging systems, which are subjected to elevated temperatures (e.g., 116-130° C.) during sterilization of the packaging material and contents (retort process).

The packaging industry is continually trying to identify adhesive solutions to eliminate this aromatic amine migration problem for health and safety reasons, while maintaining the cure speeds to which they are accustomed with conventional two component (2K) aromatic polyisocyanate-based adhesives. One approach has been to replace the aromatic polyisocyanate component in the two component (2K) polyurethane adhesive composition with aliphatic polyisocyanates. Although this approach eliminates the potential for aromatic amine formation, the lower reactivity observed with the use of aliphatic isocyanates leads to a much slower cure time. As a result, the rolled films must be stored for a much longer time (potentially up to two weeks) compared with the two to three day cure of the aromatic isocyanate-based adhesives.

Polyaspartate resins are well-known in the coatings industry. These polyaspartates are typically used in conjunction with various aliphatic polyisocyanates to produce hard, durable coatings, which can be used in applications such as floor coatings and industrial coatings. Common commercial polyaspartates are typically based on the Michael Addition product of relatively low molecular weight diamines with α,β-unsaturated diesters such as diethyl maleate. Suitable low molecular weight diamines include cycloaliphatic diamines such as 4,4′-methylenebiscyclohexylamine (PACM-20), 3,3′-dimethyl-4,4′-diaminodicyclohexylmethane (LAROMIN C260) or the acyclic aliphatic diamine 2-methylpentamethylenediamine (DYTEK A).

The polyaspartate resins described above have the advantage of relatively high reactivity with aliphatic polyisocyanates, compared to that of hydroxyl terminated resins. Furthermore, this reactivity can be readily “tuned” by varying the diamine or polyamine on which they are based and/or controlling the amount of water present, either in the resins themselves, or in the ambient environment during cure. However, these polyaspartate systems, when cured with conventional low molecular weight polyisocyanates produce hard, rather inflexible coatings which would be unsuitable for flexible packaging applications.

Thus, there continues to exist a need in the art for adhesives that: 1) can meet the mechanical requirements necessary for a film lamination adhesive; 2) do not suffer from aromatic amine migration; and 3) have sufficient cure speed so that extended cure times are not required to meet these requirements.

### SUMMARY OF THE INVENTION

The present invention provides adhesives that: 1) meet the mechanical requirements necessary for a film lamination adhesive; 2) do not suffer from aromatic amine migration; 3) have sufficient pot life to facilitate ease of application to the films to be laminated, and 4) have sufficient cure speed so that extended cure times are not required to meet these requirements. The adhesives of the invention may find use in the production of multi-layered laminated films, such as those useful in the flexible packagings market, where aromatic amine migration is a concern such as food, medical, cosmetics, and detergents packaging.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a), and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “various non-limiting embodiments,” “certain embodiments,” or the like, means that a particular feature or characteristic may be included in an embodiment. Thus, use of the phrase “in various non-limiting embodiments,” “in certain embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

In a first aspect, the invention is directed to an adhesive comprising: (A) an aliphatic polyisocyanate; and (B) an aspartate-terminated prepolymer which is a reaction product of (B1) an aliphatic NCO-terminated prepolymer having a NCO content of from 0.5% to 35%, and (B2) a compound according to formula (I)

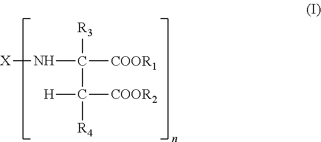

wherein, X represents a linear or branched aliphatic group obtained by removing amino groups from a linear or branched aliphatic polyamine, R₁ and R₂ are identical or different and represent organic groups which are inert towards isocyanate groups at a temperature of 100° C. or less, R₃ and R₄ are identical or different and represent hydrogen or organic groups which are inert towards isocyanate groups at a temperature of 100° C. or less, n represents an integer with a value of at least 2, wherein the aspartate-terminated prepolymer (B) has a ratio of equivalents of NH groups to equivalents of NCO groups of 1.5:1 to 20:1, (C) optionally, a solvent, wherein the adhesive has a ratio of equivalents of NCO groups in the aliphatic polyisocyanate to equivalents of NH groups of from 0.9:1 to 1.75:1, wherein pot life of the adhesive, as measured by doubling of viscosity according to ASTM D4212-16 at 23° C., is greater than or equal to 0.5 hours, and wherein the adhesive develops an acceptable bond strength to a substrate, defined as having a minimum of 150 g/in. measured @ 23° C. according to ASTM D 1876-01 or substrate tear, in less than or equal to 5 days after the substrate is laminated with the adhesive.

In a second aspect, the invention is directed to a multi-layered laminated film comprising the adhesive according the previous paragraph applied to one or more substrate layers selected from the group consisting of paper, metal and thermoplastic polymers, wherein the adhesive itself has an elongation at break of from 30% to 2000% measured according to ASTM D 412. In various embodiments, the thickness of the multi-layered laminated film may be from 10 μm to 400 μm, in selected embodiments from 10 μm to 200 μm, and in certain embodiments from 10 μm to 100 μm.

In a third aspect, the invention is directed to a process of minimizing aromatic amine migration in a packaging material, the process comprising: applying the adhesive according to the first aspect of the invention to a packaging material substrate.

The present disclosure describes flexible polyaspartates that can overcome the rigidity issues of conventional polyaspartate based polyureas, while maintaining the fast, tunable cure speed desired to provide adhesives with minimized monomeric aromatic polyamines or, in some cases, aromatic amine-free adhesives. One of the attractive features of polyaspartates is their relatively fast and tunable cure speed with aliphatic isocyanates as compared with the polyurethane systems typically employed in 2K laminated films. This reactivity can be tuned by selecting polyamines with differing degrees of steric hindrance around the amine.

Various embodiments of the present disclosure are directed to aspartate-terminated prepolymers and associated adhesives. The aspartate-terminated prepolymer is the reaction product of an NCO-functional prepolymer and a polyaspartate. The NCO-functional prepolymer used to prepare the polyaspartate terminated prepolymer is a reaction product of an aliphatic polyisocyanate and an isocyanate reactive component.

Thus, a variety of aliphatic polyisocyanates can be used to prepare the NCO-functional prepolymer. As used herein, the term “polyisocyanate” refers to compounds comprising at least two un-reacted isocyanate groups. Polyisocyanates include diisocyanates and diisocyanate reaction products comprising, for example, biuret, isocyanurate, uretdione, urethane, urea, iminooxadiazine dione, oxadiazine dione, carbodiimide, acyl urea, allophanate groups, the like, or a combination thereof. The term “aliphatic polyisocyanates” also includes cycloaliphatic polyisocyanates.

Suitable aliphatic polyisocyanates include, but are not limited to, 1,4-tetramethylene diisocyanate, 1,5-pentamethylene diisocyanate (PDI),1,6-hexamethylene diisocyanate (HDI), trimers of 1,6-hexamethylene diisocyanate (HDI), trimers of 1,5-pentamethylene diisocyanate (PDI), biurets of 1,6-hexamethylene diisocyanate (HDI), biurets of 1,5-pentamethylene diisocyanate (PDI), allophanates of 1,6-hexamethylene diisocyanate (HDI), allophanates of 1,5-pentamethylene diisocyanate (PDI), allophanates of trimers of 1,6-hexamethylene diisocyanate (HDI), allophanates of trimers of 1,5-pentamethylene diisocyanate, 2,2,4-trimethyl-hexamethylene diisocyanate, dodecamethylene diisocyanate, 2-methyl-1,5-diisocyanatopentane, 1,4-diisocyanatocyclohexane, 1-isocyanato-3,3,5-trimethyl-5-isocyanato-methylcyclohexane (IPDI), 2,4-diisocyanato-dicyclohexyl-methane, 4,4′-diisocyanato-dicyclohexyl-methane, 1,3-bis (isocyanatomethyl)-cyclohexane, 1,4-bis (isocyanatomethyl)-cyclohexane, 1-isocyanato-1-methyl-3(4)-isocyanatomethyl-cyclohexane (IMCI), bis(4-isocyanato-3-methyl-cyclohexyl)-methane, 1,4-cyclohexane diisocyanate (CHDI), and mixtures thereof.

Monomeric polyisocyanates containing three or more isocyanate groups, such as 4-isocyanatomethyl-1,8-octamethylene diisocyanate can also be used.

Aliphatic polyisocyanate adducts may also be used. Non-limiting examples of aliphatic polyisocyanate adducts include isocyanurate groups, uretdione groups, biuret groups, allophanate groups, iminooxadiazine dione groups, carbodiimide groups, oxadiazine trione groups, the like, or a combination thereof.

A variety of isocyanate reactive components may be included in the NCO-functional prepolymer to tune the physical properties (e.g., flexibility) of the resulting NCO-functional prepolymer and aspartate-terminated prepolymer. For example, the isocyanate reactive component can generally include a polyol or polyamine having a number average molecular weight of from 300 to 6000 which is based on one of a polyether, a polyester, a polycarbonate, a polycarbonate ester, a polycaprolactone, a polybutadiene, the like, or a combination thereof.

Various embodiments include polyether polyols formed from the oxyalkylation of various polyols, including glycols such as ethylene glycol, 1,2-1,3- or 1,4-butanediol, 1,6-hexanediol, and the like, or higher polyols, such as trimethylol propane, pentaerythritol and the like. One useful oxyalkylation method is by reacting a polyol with an alkylene oxide, for example, ethylene oxide or propylene oxide in the presence of a basic catalyst or a coordination catalyst such as a double-metal cyanide (DMC).

Suitable polyester polyols can be prepared by the polyesterification of organic polycarboxylic acids, anhydrides thereof, or esters thereof with organic polyols. Preferably, the polycarboxylic acids and polyols are aliphatic or aromatic dibasic acids and diols.

The diols which may be employed in making the polyester include alkylene glycols, such as ethylene glycol, 1,2-1,3- or 1,4-butanediol, neopentyl glycol and other glycols such as cyclohexane dimethanol, caprolactone diol (for example, the reaction product of caprolactone and ethylene glycol), polyether glycols, for example, poly(oxytetramethylene) glycol and the like. However, other diols of various types and, as indicated, polyols of higher functionality may also be utilized in various embodiments of the invention. Such higher polyols can include, for example, trimethylol propane, trimethylol ethane, pentaerythritol, and the like, as well as higher molecular weight polyols such as those produced by oxyalkylating low molecular weight polyols.

The acid component of the polyester consists primarily of monomeric carboxylic acids, or anhydrides thereof, or esters thereof having 2 to 18 carbon atoms per molecule. Among the acids which are useful are phthalic acid, isophthalic acid, terephthalic acid, tetrahydrophthalic acid, hexahydrophthalic acid, adipic acid, succinic acid, azelaic acid, sebacic acid, maleic acid, glutaric acid, chlorendic acid, tetrachlorophthalic acid and other dicarboxylic acids of varying types. Also, there may be employed higher polycarboxylic acids such as trimellitic acid and tricarballylic acid.

In addition to polyester polyols formed from polybasic acids and polyols, polycaprolactone-type polyesters can also be employed. These products are formed from the reaction of a cyclic lactone such as ε-caprolactone with a polyol containing primary hydroxyls such as those mentioned above. Such products are described, for example, in U.S. Pat. No. 3,169,949.

Suitable hydroxy-functional polycarbonate polyols may be those prepared by reacting monomeric diols (such as 1,4-butanediol, 1,6-hexanediol, di-, tri- or tetraethylene glycol, di-, tri- or tetrapropylene glycol, 3-methyl-1,5-pentanediol, 4,4′-dimethylolcyclohexane and mixtures thereof) with diaryl carbonates (such as diphenyl carbonate, dialkyl carbonates (such as dimethyl carbonate and diethyl carbonate), alkylene carbonates (such as ethylene carbonate or propylene carbonate), or phosgene. Optionally, a minor amount of higher functional, monomeric polyols, such as trimethylolpropane, glycerol or pentaerythritol, may be used.

In various embodiments, low molecular weight diols, triols, and higher alcohols may be included in the NCO-functional prepolymer. In many embodiments, they are monomeric and have hydroxyl values of 375 to 1810. Such materials can include aliphatic polyols, particularly alkylene polyols containing from 2 to 18 carbon atoms. Examples include ethylene glycol, 1,4-butanediol, 1,6-hexanediol, and cycloaliphatic polyols such as cyclohexane dimethanol. Examples of triols and higher alcohols include trimethylol propane and pentaerythritol. Also useful are polyols containing ether linkages such as diethylene glycol and triethylene glycol.

The polyisocyanate and the isocyanate reactive component may be combined and allowed to react at a ratio to generate an NCO-functional prepolymer having from 0.5% NCO to 35% NCO. In various embodiments, the NCO-functional prepolymer has from 0.5% NCO to 25% NCO, from 1% NCO to 20% NCO, from 5% NCO to 15% NCO. In any case, an excess of aliphatic polyisocyanate is employed to generate an NCO-functional prepolymer. Additionally, in some embodiments, the resulting NCO-functional prepolymer can be stripped to remove residual monomeric polyisocyanate (e.g., via thin-film evaporation) prior to terminating with the polyaspartate.

As described elsewhere herein, aliphatic polyisocyanates generally have lower reactivity and slower cure times than aromatic polyisocyanates in two-component (2K) adhesive systems. With this in mind, the polyaspartate can serve multiple functions in the aspartate-terminated prepolymer, depending on the particular formulation. For example, the aspartate-terminated prepolymer can have a faster reaction rate with a co-reactant polyisocyanate component than the polyols that are generally used in the art.

In certain embodiments, the aspartate-terminated prepolymer can be prepared with a variety of polyaspartate components. As those skilled in the art are aware, polyaspartates may be produced by the reaction of a polyamine with a Michael addition receptor, i.e., an olefin substituted on one or both of the olefinic carbons with an electron withdrawing group such as cyano, keto, or ester (an electrophile) in a Michael addition reaction. Examples of suitable Michael addition receptors include, but are not limited to, acrylates, and diesters such as dimethyl maleate, diethyl maleate, dibutyl maleate, dimethyl fumarate, diethyl fumarate, and dibutyl fumarate.

The polyaspartate may include one or more polyaspartates corresponding to formula (I):

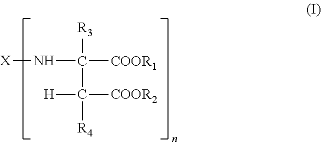

wherein:
n is an integer of at least 2;
X represents an aliphatic residue;
R₁ and R₂ each independently represent organic groups that are inert to isocyanate groups under reaction conditions; and
R₃ and R₄ each independently represent hydrogen or organic groups that are inert to isocyanate groups under reaction conditions.

As will be described in further detail, the polyaspartate can be prepared with a variety of polyamines, including low molecular weight polyamines, high molecular weight polyamines, or a combination thereof. Additionally, the polyamines can have a wide range of amine functionality, repeat unit type, distribution, etc. This wide range of molecular weight, amine functionality, repeating unit type, and distribution can provide versatility in the design of new compounds or mixtures.

Suitable low molecular weight polyamines have molecular weights in various embodiments of from 60 to 400, in selected embodiments of from 60 to 300. Suitable low-molecular-weight polyamines include, but are not limited to, ethylene diamine, 1,2- and 1,3-diaminopropane, 1,5-diaminopentane, 1,3-, 1,4- and 1,6-diaminohexane, 1,3-diamino-2,2-dimethyl propane, 2-methyl-1,5-pentane diamine, isophorone diamine, 4,4′-diamino-dicyclohexyl methane, 4,4′-diamino-3,3′-dimethyldicyclohexyl methane, 1,4-bis(2-amino-prop-2-yl)-cyclohexane, hydrazine, piperazine, bis(4-aminocyclohexyl)methane, and mixtures of such polyamines. Representative polyaspartates prepared from these low molecular weight polyamines include DESMOPHEN NH-1220, DESMOPHEN NH-1420, and DESMOPHEN NH-1520, all commercially available from Covestro.

In some embodiments of the invention, a single high molecular weight polyamine may be used. Also, mixtures of high molecular weight polyamines, such as mixtures of di- and trifunctional materials and/or different molecular weight or different chemical composition materials, may be used. The term “high molecular weight” is intended to include polyamines having a molecular weight of at least 400 in various embodiments. In selected embodiments, the polyamines have a molecular weight of from 400 to 6,000. Non-limiting examples can include polyethylene glycol bis(amine) polypropylene glycol (bis amine), or polytetramethylene glycol bis (amine), the like, or a combination thereof.

In certain embodiments, the polyamine can be for example, one or more of the JEFFAMINE series of amine-terminated polyethers from Huntsman Corp., such as, JEFFAMINE D-230, JEFFAMINE D-400, JEFFAMINE D-2000, JEFFAMINE D-4000, JEFFAMINE T-3000 and JEFFAMINE T-5000.

In some embodiments, the resulting aspartate-terminated prepolymer can be further diluted in an organic solvent. In other words, the aspartate-terminated prepolymer can further include an organic solvent as a diluent. Non-limiting examples of organic solvents can include ethyl acetate, butyl acetate, methyl ethyl ketone, methyl isobutyl ketone, methoxypropyl acetate, N-methyl pyrrolidone, petroleum hydrocarbons, the like, or a combination thereof.

In those embodiments where the aspartate-terminated prepolymer is diluted in an organic solvent, it can be diluted to various degrees to maintain a reasonable viscosity for the intended application. In those embodiments, the aspartate-terminated prepolymer solution can include from 20 wt. % to 90 wt. % solids based on a total weight of the aspartate-terminated prepolymer plus the solvent. In certain embodiments, the aspartate-terminated prepolymer solution can include from 20 wt. % to 60 wt. % or from 40 wt. % to 90 wt. % solids based on a total weight of the aspartate-terminated prepolymer plus the solvent. In various embodiments, the aspartate-terminated prepolymer solution can include from 20 wt. % to 40 wt. %, from 30 wt. % to 50 wt. %, from 40 wt. % to 60 wt. %, from 50 wt. % to 70 wt. %, from 60 wt. % to 80 wt. %, or from 70 wt. % to 90 wt. % solids, based on a total weight of the aspartate-terminated prepolymer plus the solvent.

The aspartate-terminated prepolymer or aspartate-terminated prepolymer solution is part of a multiple-component, such as a two-component (2K), adhesive system, which includes a co-reactant polyisocyanate or polyisocyanate prepolymer component for combination with the aspartate-terminated prepolymer to form the adhesive.

In some embodiments, a variety of aliphatic polyisocyanate components can be included in the adhesives. For example, in certain embodiments, the aliphatic polyisocyanate component can be or include monomeric polyisocyanate, such as any of the aliphatic polyisocyanate monomers and aliphatic polyisocyanate adducts described elsewhere herein, or a combination thereof. In some embodiments, the polyisocyanate component can be or include an aliphatic polyisocyanate prepolymer, and may optionally be diluted with solvent to reduce viscosity in a manner similar to that described herein of the aspartate-terminated prepolymer component of the adhesive.

Where the aliphatic polyisocyanate component includes an aliphatic polyisocyanate prepolymer, the polyisocyanate prepolymer can be a reaction product of a second aliphatic polyisocyanate and a second isocyanate reactive component. The types of polyisocyanates employed in the polyisocyanate prepolymer includes the same polyisocyanates and polyisocyanate adducts listed herein with reference to the NCO-functional prepolymer. Similarly, the types of isocyanate reactive components employed in the polyisocyanate prepolymer can include those listed herein with reference to the NCO-functional prepolymer. In some embodiments, the polyisocyanate prepolymer can be the same as the NCO-functional prepolymer. In certain embodiments, the polyisocyanate prepolymer can be different from the NCO-functional prepolymer. In selected embodiments, the polyisocyanate prepolymer can include the same polyisocyanate(s) as the NCO-functional prepolymer, and the same or different isocyanate reactive component(s). In embodiments, the polyisocyanate and the isocyanate reactive component of the polyisocyanate prepolymer can be combined at a ratio to produce a polyisocyanate prepolymer having from 0.5% NCO to 35% NCO, in others, 2% NCO to 12% NCO, from 10% NCO to 18% NCO, from 12% to 20% NCO, or from 18% NCO to 25% NCO.

As previously mentioned, the inventive adhesives can be reacted and cured.

The aspartate-terminated prepolymer and the aliphatic polyisocyanate component can be combined at a variety of ratios to produce an adhesive. In various embodiments, the viscosity of the 2K mixture at 23° C. will require at least 0.5 hours to double, in certain embodiments, the viscosity at 23° C. will require at least 2 hours to double, in other embodiments, at least 4 hours to double and in selected embodiments, the viscosity at 23° C. will require at least 7 hours to double in viscosity.

The present disclosure also describes a method of minimizing aromatic amine migration in multi-layered substrate such as a packaging material. This method includes forming or applying an adhesive as described herein to a substrate of the packaging material and curing the adhesive.

The inventive adhesive can be formed on or applied to a variety of substrates, including multi-layered laminate films such as those for packaging materials or the like, particularly flexible packaging materials. Non-limiting examples of substrates include metals (aluminum, copper, and steel), plastics, wood, cement, concrete, glass, the like, or a combination thereof. The adhesive of the invention can be applied by painting, rolling, pouring, spraying, dipping, casting, dispensing, the like, or a combination thereof. The inventive adhesive and substrate layers may be laminated together by processes known in the art.

### EXAMPLES

The non-limiting and non-exhaustive examples that follow are intended to further describe various non-limiting and non-exhaustive embodiments without restricting the scope of the embodiments described in this specification. All quantities given in “parts” and “percents” are understood to be by weight, unless otherwise indicated. Although the present invention is described in the instant Examples in the context of an adhesive, those skilled in the art will appreciate it can also be equally applicable to coatings, castings, composites, and sealants.

The following materials were used in preparing the compositions of the Examples:

| | |
|---|---|
| POLYESTER A | a diethylene glycol and phthalic anhydride polyester diol |
| | having a hydroxyl value of 320 mg KOH/g; |
| POLYESTER B | a diethylene glycol and adipic acid polyester diol having a |
| | hydroxyl value of 225 mg KOH/g; |
| POLYETHER A | a polypropylene glycol polyether diol having a hydroxyl |
| | value of 111 mg KOH/g commercially available from |
| | Covestro LLC as ARCOL PPG 1000; |
| DIASPARTATE A | a diaspartate prepared from 4,4′- |
| | diaminodicyclohexylmethane and diethyl maleate having |
| | an approximate amine value of 204 mg KOH/g |
| | commercially available from Covestro LLC as |
| | DESMOPHEN NH 1423; |
| DIISOCYANATE A | an aliphatic diisocyanate (1,6-hexamethylene diisocyanate) |
| | with an average isocyanate content of 49.7 wt. % and |
| | commercially available from Covestro LLC as |
| | DESMODUR H; |
| POLYISOCYANATE A | an NCO terminated prepolymer based on |
| | DIISOCYANATE A and a polypropylene oxide polyether |
| | diol (hydroxyl value of 515 mg KOH/g.), the prepolymer |
| | had an isocyanate content of 12.5 wt. % commercially |
| | available from Covestro LLC as DESMODUR XP 2617; |
| POLYISOCYANATE B | HDI trimer (isocyanurate) having an average isocyanate |
| | content of 21.8 wt. % , commercially available from |
| | Covestro LLC as DESMODUR N-3300; and |
| ETHYL ACETATE | commercially available from Sigma Aldrich. |

### Synthesis of OH-TERMINATED PREPOLYMER A

DIISOCYANATE A (19 g) was added to a round bottom flask fitted with a stirrer, heating mantel, and thermocouple under a nitrogen blanket. POLYESTER A (151 g) was added dropwise through an addition funnel over the course of 60 minutes. The mixture was held at constant temperature until FTIR analysis showed no NCO peak. The resulting OH-TERMINATED PREPOLYMER A had a measured hydroxyl value of 206 mg KOH/g.

### Synthesis of NCO-TERMINATED PREPOLYMER A

DIISOCYANATE A (284.5 g) was added to a round bottom flask fitted with a stirrer, heating mantel, and thermocouple under a nitrogen blanket. POLYESTER A (315.5 g) was added dropwise through an addition funnel over the course of 60 minutes. The mixture was held at constant temperature until the theoretical % NCO value was reached. The resulting NCO-TERMINATED PREPOLYMER A had an NCO content of 9.86% @ 91% solids in dry ETHYL ACETATE.

### Synthesis of ASPARTATE-TERMINATED PREPOLYMER A

DIASPARTATE A (84.2 g) was added to a round bottom flask fitted with a stirrer, heating mantel, and a thermocouple under a nitrogen blanket. NCO-TERMINATED PREPOLYMER A (65.8 g) was added dropwise through an addition funnel over the course of 60 minutes. Dry ETHYL ACETATE was added as needed to control viscosity. The mixture was held at constant temperature until there was no discernable NCO peak visible through FTIR analysis. The resulting ASPARTATE-TERMINATED PREPOLYMER A had an amine value of 38.2 mg KOH/g at 68.4% solids.

### Synthesis of NCO-TERMINATED PREPOLYMER B

DIISOCYANATE A (78.4 g) was added to a round bottom flask fitted with a stirrer, heating mantel, and thermocouple under a nitrogen blanket. POLYESTER B (121.6 g) was added dropwise through an addition funnel over the course of 60 minutes. The mixture was held at constant temperature until the theoretical % NCO value was reached. The resulting NCO-TERMINATED-PREPOLYMER B had a final NCO content of 9.03% @ 100% solids.

### Synthesis of ASPARTATE-TERMINATED PREPOLYMER B

DIASPARTATE A (107.9 g) was added to a round bottom flask fitted with a stirrer, heating mantel, and a thermocouple under a nitrogen blanket. NCO TERMINATED PREPOLYMER B (91.8 g) was added dropwise through an addition funnel over the course of 60 minutes. Dry ETHYL ACETATE was added as needed to control viscosity. The mixture was held at constant temperature until there was no discernable NCO peak visible through FTIR analysis. The resulting ASPARTATE-TERMINATED PREPOLYMER B had an amine value of 38.5 mg KOH/g at 69.8% solids.

### Synthesis of NCO-TERMINATED PREPOLYMER C

DIISOCYANATE A (230.2 g) was added to a round bottom flask fitted with a stirrer, heating mantel, and thermocouple under a nitrogen blanket. POLYESTER A (188.5 g) and POLYETHER A (181.2 g) was mixed until homogeneous and then added dropwise through an addition funnel over the course of 60 minutes. The mixture was held at constant temperature until the theoretical % NCO value was reached. The resulting NCO-TERMINATED-PREPOLYMER C had a final NCO content of 9.10% @ 100% solids.

### Synthesis of ASPARTATE-TERMINATED PREPOLYMER C

DIASPARTATE A (108.3 g) was added to a round bottom flask fitted with a stirrer, heating mantel, and a thermocouple under a nitrogen blanket. NCO TERMINATED PREPOLYMER C (91.7 g) was added dropwise through an addition funnel over the course of 60 minutes. Dry ETHYL ACETATE was added as needed to control viscosity. The mixture was held at constant temperature until there was no discernable NCO peak visible through FTIR analysis. The resulting ASPARTATE-TERMINATED PREPOLYMER C had an amine value of 38.5 mg KOH/g at 66.9% solids.

### Synthesis of NCO-TERMINATED PREPOLYMER D

Diisocyanate A (203.3 g) was added to a round bottom flask fitted with a stirrer, heating mantel, and thermocouple under a nitrogen blanket. POLYESTER B (236.7 g) and POLYETHER A (160.0 g) was mixed until homogeneous and then added dropwise through an addition funnel over the course of 60 minutes. The mixture was held at constant temperature until the theoretical % NCO value was reached. The resulting NCO-TERMINATED PREPOLYMER D had a final NCO content of 7.76% @ 100% solids.

### Synthesis of ASPARTATE-TERMINATED PREPOLYMER D

DIASPARTATE A (100.3 g) was added to a round bottom flask fitted with a stirrer, heating mantel, and a thermocouple under a nitrogen blanket. NCO-TERMINATED PREPOLYMER D (99.7 g) was added dropwise through an addition funnel over the course of 60 minutes. Dry ETHYL ACETATE was added as needed to control viscosity. The mixture was held at constant temperature until there was no discernable NCO peak visible through FTIR analysis. The resulting ASPARTATE-TERMINATED PREPOLYMER D had an amine value of 35.1 mg KOH/g at 68.0% solids.

### Synthesis of ASPARTATE-TERMINATED PREPOLYMER E

DIASPARTATE A (99.2 g) was added to a round bottom flask fitted with a stirrer, heating mantel, and a thermocouple under a nitrogen blanket. NCO-TERMINATED PREPOLYMER B (110.8 g) was added dropwise through an addition funnel over the course of 60 minutes. Dry ETHYL ACETATE was added as needed in order to control viscosity. The mixture was held at constant temperature until there was no discernable NCO peak visible through FTIR analysis. The resulting ASPARTATE TERMINATED PREPOLYMER E had an amine value of 25.5 mg KOH/g at 72.5% solids.

### Synthesis of ASPARTATE-TERMINATED PREPOLYMER F

DIASPARTATE A (134.8 g) was added to a round bottom flask fitted with a stirrer, heating mantel, and a thermocouple under a nitrogen blanket. NCO-TERMINATED PREPOLYMER B (75.2 g) was added dropwise through an addition funnel over the course of 60 minutes. Dry ETHYL ACETATE was added as needed in order to control viscosity. The mixture was held at constant temperature until there was no discernable NCO peak visible through FTIR analysis. The resulting ASPARTATE TERMINATED PREPOLYMER F had an amine value of 62.8 mg KOH/g at 70.6% solids.

### General Adhesive Preparation and Testing Procedures

### Bond Strength

In the following Examples, the isocyanate functional material and either the amino or hydroxyl functional material were combined at 23° C. at an NCO/(OH or NH) ratio of 1.15 to 1.00. The samples were diluted to 50% solids using dry ETHYL ACETATE to assure consistent adhesive application thickness between samples. Each formulation was applied to corona-treated polyethylene terephthalate (PET) film using a wire wound rod, resulting in a dry adhesive film weight of between 2.5-5.0 g/m². The samples were dried at 60° C. for 60 seconds, then laminated to corona-treated PET, metalized PET (MPET), corona-treated cast polypropylene (cPP) and aluminum foil (Al) using a hot roll laminator at 50 prig, 65° C. traveling at two feet per minute.

Bond strength measurements according to ASTM D 1876-01, were conducted using an INSTRON machine at a peel rate of 12 in/min. at time intervals of four hours, one day, seven days and 14 days after lamination. All results are given in g/in. with failure modes designated as follows: ST is “Substrate Tear” meaning one or more of the substrates tore during analysis; P is “Peel” meaning the sample smoothly peeled during analysis; Z is “Zipper” meaning the sample rapidly increased and decreased in bond strength during analysis; C is “Cohesive” meaning the adhesive split during analysis partially staying adhered to both substrates; and AF is “Adhesive Failure” meaning the adhesive completely and cleanly separated from one of the two substrates during analysis. Bond strength results are presented in the Tables. In various embodiments of the invention, the laminates develop acceptable bond strength—defined for the purposes of the invention as having a minimum of 150 g/in. measured @ 23° C. according to ASTM D 1876-01 or substrate tear—in less than 5 days at 23° C., in some embodiments, in from 1 to 5 days at 23° C. and in certain embodiments in less than 1 day at 23° C.

### Pot-Life

In the following Examples, the isocyanate functional material and either the amino or hydroxyl functional material were combined at 23° C. at an NCO/(OH or NH) ratio of 1.15:1.00. The samples were then diluted using dry ETHYL ACETATE to a viscosity of 18 seconds in a #2 EZ Zahn cup. Viscosity was monitored according to ASTM D4212-16 at 23° C. and recorded at time intervals of initial, one hour, two hours, four hours and eight hours. All results are given in seconds (s).

### Tensile Strength of the Adhesive Itself

In the following Examples, the isocyanate functional material and either the amino or hydroxyl functional material were combined at 23° C. at an NCO/(OH or NH) ratio of 1.15 to 1.00. The samples were applied to a release liner using a 10 mil draw down bar and cured for a minimum of seven days at 23° C. and 50% relative humidity. Cured samples were tested according to ASTM D 412 using an INSTRON machine at a rate of 20 in/min. measuring the stress (psi) and elongation (%) at break.

### Comparative Example 1

OH-TERMINATED PREPOLYMER A (41 g) was added to POLYISOCYANATE A (59 g) and mixed for 60 seconds until homogeneous. Table I provides bond strength measurements. Pot-life measurements were, initial: 13 s; one hour: 13 s; two hours: 13 s; four hours: 13 s; and eight hours: 13 s. Tensile strength was 5 psi at break and elongation at break was 695%. This comparative example required 20 days of curing to reach the measured tensile and elongation value. At 7 days, the sample could not be tested for tensile and elongation due to insufficient cure. Comparative Example 1 exemplifies the current industry standard for flexible packaging adhesives.

TABLE I
Bond Strength (g/in.)

| Laminate Structure | 4 Hours | 1 Day | 7 Days | 14 Days |
|---|---|---|---|---|
| PET/PET | 0 | 0 | 752 ^{ST} | 881 ^{ST} |
| PET/MPET | 0 | 0 | 829 ^{ST} | 959 ^{ST} |
| PET/cPP | 0 | 0 | 1452 ^{P} | 1296 ^{P} |
| PET/Al | 0 | 0 | 804 ^{ST} | 881 ^{ST} |

Note:
ST = Substrate Tear;
P = Peel;
Z = Zipper;
C = Cohesive;
and AF = Adhesive Failure

### Comparative Example 2

DIASPARTATE A (55.7 g) was added to POLYISOCYANATE B (44.3 g) and mixed for 60 seconds until homogeneous. Table II provides bond strength measurements. Pot-life measurements were, initial: 18 s; one hour: 28 s; two hours: 150 s; four hours: gel; and eight hours; gel. Tensile strength was 5505 psi at break and elongation at break was 9%.

TABLE II
Bond Strength (g/in.)

| Laminate Structure | 4 Hours | 1 Day | 7 Days | 14 Days |
|---|---|---|---|---|
| PET/PET | 181 ^{AF} | 493 ^{ST} | 1063 ^{ST} | 518 ^{ST} |
| PET/MPET | 181 ^{AF} | 78 ^{C} | 596 ^{ST} | 207 ^{ST} |
| PET/cPP | 104 ^{AF} | 181 ^{C} | 155 ^{AF} | 130 ^{AF} |
| PET/Al | 104 ^{AF} | 26 ^{AF} | 104 ^{AF} | 181 ^{AF} |

Note:
ST = Substrate Tear;
P = Peel;
Z = Zipper;
C = Cohesive;
and AF = Adhesive Failure

### Example 3

ASPARTATE-TERMINATED PREPOLYMER A (72.2 g) was added to POLYISOCYANATE A (27.8 g) and mixed for 60 seconds until homogeneous. Table III provides bond strength measurements. Pot-life measurements were, initial: 16 s; one hour: 22 s; two hours: 31 s; four hours: 52 s; and eight hours: 130 s. Tensile strength was 1550 psi at break and elongation at break was 340%.

TABLE III
Bond Strength (g/in.)

| Laminate Structure | 4 Hours | 1 Day | 7 Days | 14 Days |
|---|---|---|---|---|
| PET/PET | 907 ^{ST} | 985 ^{ST} | 1115 ^{ST} | 1089 ^{ST} |
| PET/MPET | 207 ^{P} | 933 ^{ST} | 467 ^{ST} | 470 ^{ST} |
| PET/cPP | 181 ^{P} | 130 ^{P} | 104 ^{P} | 78 ^{P} |
| PET/Al | 130 ^{P} | 104 ^{P} | 130 ^{P} | 78 ^{P} |

Note:
ST = Substrate Tear;
P = Peel;
Z = Zipper;
C = Cohesive;
and AF = Adhesive Failure

### Example 4

ASPARTATE-TERMINATED PREPOLYMER B (72.9 g) was added to POLYISOCYANATE A (27.1 g) and mixed for 60 seconds until homogeneous. Table IV provides bond strength measurements. Pot-life measurements were, initial: 19 s; one hour: 25 s; two hours: 32 s; four hours: 49 s; and eight hours: 180 s. Tensile strength was 2993 psi at break and elongation at break was 698%.

TABLE IV
Bond Strength (g/in.)

| Laminate Structure | 4 Hours | 1 Day | 7 Days | 14 Days |
|---|---|---|---|---|
| PET/PET | 985 ^{ST} | 3655 ^{ST} | 1218 ^{ST} | 1218 ^{ST} |
| PET/MPET | 1037 ^{ST} | 2333 ^{ST} | 467 ^{ST} | 674 ^{ST} |
| PET/cPP | 1555 ^{Z} | 3759 ^{Z} | 2515 ^{Z} | 3085 ^{ST} |
| PET/Al | 778 ^{Z} | 2515 ^{Z} | 959 ^{ST} | 1555 ^{ST} |

Note:
ST = Substrate Tear;
P = Peel;
Z = Zipper;
C = Cohesive;
and AF = Adhesive Failure

### Example 5

ASPARTATE-TERMINATED PREPOLYMER B (82.4 g) was added to POLYISOCYANATE B (17.6 g) and mixed for 60 seconds until homogeneous. Table V provides bond strength measurements. Pot-life measurements were, initial: 22 s; one hour: 39 s; two hours: 80 s; four hours: 147 s; and eight hours: gel. Tensile strength was 2192 psi at break and elongation at break was 140%

TABLE V
Bond Strength (g/in.)

| Laminate Structure | 4 Hours | 1 Day | 7 Days | 14 Days |
|---|---|---|---|---|
| PET/PET | 1244 ^{ST} | 1970 ^{ST} | 570 ^{ST} | 570 ^{ST} |
| PET/MPET | 570 ^{ST} | 2307 ^{ST} | 441 ^{ST} | 855 ^{ST} |
| PET/cPP | 1011 ^{Z} | 2774 ^{Z} | 1063 ^{Z} | 1089 ^{ST} |
| PET/Al | 985 ^{AF} | 2566 ^{AF} | 285 ^{AF} | 337 ^{AF} |

Note:
ST = Substrate Tear;
P = Peel;
Z = Zipper;
C = Cohesive;
and AF = Adhesive Failure

### Example 6

ASPARTATE-TERMINATED PREPOLYMER C (71.6 g) was added to POLYISOCYANATE A (28.4 g) and mixed for 60 seconds until homogeneous. Table VI provides bond strength measurements. Pot-life measurements were, initial: 16 s; one hour: 24 s; two hours: 33 s; four hours: 55 s; and eight hours: 120 s. Tensile strength was 2856 psi at break and elongation at break was 461%.

TABLE VI
Bond Strength (g/in.)

| Laminate Structure | 4 Hours | 1 Day | 7 Days | 14 Days |
|---|---|---|---|---|
| PET/PET | 752 ^{ST} | 778 ^{ST} | 907 ^{ST} | 933 ^{ST} |
| PET/MPET | 181 ^{ST} | 441 ^{ST} | 959 ^{ST} | 570 ^{ST} |
| PET/cPP | 1555 ^{Z} | 1607 ^{Z} | 2644 ^{ST} | 3059 ^{ST} |
| PET/Al | 544 ^{AF} | 311 ^{AF} | 233 ^{AF} | 648 ^{AF} |

Note:
ST = Substrate Tear;
P = Peel;
Z = Zipper;
C = Cohesive;
and AF = Adhesive Failure

### Example 7

ASPARTATE-TERMINATED PREPOLYMER C (81.5 g) was added to POLYISOCYANATE B (18.5 g) and mixed for 60 seconds until homogeneous. Table VII provides bond strength measurements. Pot-life measurements were, initial: 21 s; one hour: 58 s; two hours: 120 s; four hours: gel; and eight hours: gel. Tensile strength was 2503 psi at break and elongation at break was 34%.

TABLE VII
Bond Strength (g/in.)

| Laminate Structure | 4 Hours | 1 Day | 7 Days | 14 Days |
|---|---|---|---|---|
| PET/PET | 467 ^{ST} | 493 ^{ST} | 907 ^{ST} | 596 ^{ST} |
| PET/MPET | 544 ^{C} | 648 ^{ST} | 778 ^{ST} | 881 ^{ST} |
| PET/cPP | 1633 ^{Z} | 700 ^{Z} | 855 ^{Z} | 2437 ^{Z} |
| PET/Al | 181 ^{AF} | 181 ^{AF} | 156 ^{AF} | 156 ^{AF} |

Note:
ST = Substrate Tear;
P = Peel;
Z = Zipper;
C = Cohesive;
and AF = Adhesive Failure

### Example 8

ASPARTATE-TERMINATED PREPOLYMER D (73.8 g) was added to POLYISOCYANATE A (26.3 g) and mixed for 60 seconds until homogeneous. Table VIII provides bond strength measurements. Pot-life measurements were, initial: 18 s; one hour: 26 s; two hours: 36 s; four hours: 63 s; and eight hours: 149 s. Tensile strength was 2956 psi at break and elongation at break was 737%.

TABLE VIII
Bond Strength (g/in.)

| Laminate Structure | 4 Hours | 1 Day | 7 Days | 14 Days |
|---|---|---|---|---|
| PET/PET | 1270 ^{ST} | 1244 ^{ST} | 1633 ^{ST} | 1218 ^{ST} |
| PET/MPET | 700 ^{ST} | 726 ^{ST} | 726 ^{ST} | 752 ^{ST} |
| PET/cPP | 1685 ^{Z} | 2307 ^{Z} | 3214 ^{ST} | 4666 ^{ST} |
| PET/Al | 596 ^{AF} | 804 ^{AF} | 778 ^{AF} | 778 ^{AF} |

Note:
ST = Substrate Tear;
P = Peel;
Z = Zipper;
C = Cohesive;
and AF = Adhesive Failure

### Example 9

ASPARTATE-TERMINATED PREPOLYMER D (83.1 g) was added to POLYISOCYANATE B (16.9 g) and mixed for 60 seconds until homogeneous. Table IX provides bond strength measurements. Pot-life measurements were, initial: 21 s; one hour: 29 s; two hours: 48 s; four hours: 94 s; and eight hours: gel. Tensile strength was 2079 psi at break and elongation at break was 151%.

TABLE IX
Bond Strength (g/in.)

| Laminate Structure | 4 Hours | 1 Day | 7 Days | 14 Days |
|---|---|---|---|---|
| PET/PET | 752 ^{ST} | 778 ^{ST} | 933 ^{ST} | 933 ^{ST} |
| PET/MPET | 337 ^{ST} | 233 ^{ST} | 233 ^{ST} | 311 ^{ST} |
| PET/cPP | 1892 ^{Z} | 1659 ^{Z} | 2307 ^{ST} | 3344 ^{ST} |
| PET/Al | 467 ^{AF} | 363 ^{AF} | 441 ^{AF} | 493 ^{AF} |

Note:
ST = Substrate Tear;
P = Peel;
Z = Zipper;
C = Cohesive;
and AF = Adhesive Failure

### Example 10

ASPARTATE TERMINATED PREPOLYMER E (86.1 g) was added to POLYISOCYANATE A (14.0 g) and mixed for 60 seconds until homogeneous. Table X provides bond strength measurements. Pot-life measurements were, initial: 21 s; one hour: 21 s; two hours: 21 s; four hours: 22 s; and eight hours: 25 s. Tensile strength was 2115 psi at break and elongation at break was 1035%.

TABLE X
Bond Strength (g/in.)

| Laminate Structure | 4 Hours | 1 Day | 7 Days | 14 Days |
|---|---|---|---|---|
| PET/PET | 622^{C} | 1166^{ST} | 1115^{ST} | |
| PET/MPET | 942^{C} | 873^{ST} | 687^{ST} | |
| PET/cPP | 380^{Z} | 415^{Z} | 985^{AF} | |
| PET/Al | 639^{AF} | 639^{AF} | 531^{AF} | |

Note:
ST = Substrate Tear;
P = Peel;
Z = Zipper;
C = Cohesive;
and AF = Adhesive Failure

### Example 11

ASPARTATE TERMINATED PREPOLYMER E (91.5 g) was added to POLYISOCYANATE B (8.6 g) and mixed for 60 seconds until homogeneous. Table XI provides bond strength measurements. Pot-life measurements were, initial: 21 s; one hour: 22 s; two hours: 22 s; four hours: 26 s; and eight hours: 35 s. Tensile strength was 2446 psi at break and elongation at break was 418%.

TABLE XI
Bond Strength (g/in.)

| Laminate Structure | 4 Hours | 1 Day | 7 Days | 14 Days |
|---|---|---|---|---|
| PET/PET | 389^{Z} | 1382^{ST} | 2540 ^{ST} | |
| PET/MPET | 812^{ST} | 640^{ST} | 713^{ST} | |
| PET/cPP | 449^{Z} | 553^{Z} | 596^{Z} | |
| PET/Al | 536^{AF} | 562^{AF} | 415^{AF} | |

Note:
ST = Substrate Tear;
P = Peel;
Z = Zipper;
C = Cohesive;
and AF = Adhesive Failure

### Example 12

ASPARTATE TERMINATED PREPOLYMER F (70.0 g) was added to POLYISOCYANATE A (30.0 gr) and mixed for 60 seconds until homogeneous. Table XII provides bond strength measurements. Pot-life measurements were, initial: 20 s; one hour: 25 s; two hours: 29 s; four hours: 42 s; and eight hours: 64 s. Tensile strength was 2866 psi at break and elongation at break was 338%.

TABLE XII
Bond Strength (g/in.)

| Laminate Structure | 4 Hours | 1 Day | 7 Days | 14 Days |
|---|---|---|---|---|
| PET/PET | 1348^{ST} | 1037^{ST} | 1128^{ST} | |
| PET/MPET | 553^{ST} | 717^{ST} | 804^{ST} | |
| PET/cPP | 259^{Z} | 259^{Z} | 311^{Z} | |
| PET/Al | 553^{AF} | 579^{AF} | 687^{AF} | |

Note:
ST = Substrate Tear;
P = Peel;
Z = Zipper;
C = Cohesive;
and AF = Adhesive Failure

### Example 13

ASPARTATE TERMINATED PREPOLYMER F (80.3 g) was added to POLYISOCYANATE B (19.7 g) and mixed for 60 seconds until homogeneous. Table XIII provides bond strength measurements. Pot-life measurements were, initial: 20 s; one hour: 27 s; two hours: 42 s; four hours: 108 s; and eight hours: gel. Tensile strength was not tested.

TABLE XIII
Bond Strength (g/in.)

| Laminate Structure | 4 Hours | 1 Day | 7 Days | 14 Days |
|---|---|---|---|---|
| PET/PET | 0 | 0 | 0 | |
| PET/MPET | 829^{ST} | 881^{ST} | 596^{ST} | |
| PET/cPP | 0 | 0 | 0 | |
| PET/Al | 173^{AF} | 95^{AF} | 78^{AF} | |

Note:
ST = Substrate Tear;
P = Peel;
Z = Zipper;
C = Cohesive;
and AF = Adhesive Failure

Table XIV summarizes the results of the Examples. As will be apparent to those skilled in the art upon consideration of Table XIV, Examples 4-12 demonstrate that the inventive adhesives, prepared from aspartate-terminated prepolymers and either difunctional or polyfunctional aliphatic isocyanates, can be used to prepare adhesives suitable for multi-layered film laminates such as flexible packaging laminates. The inventive adhesives are characterized by sufficient pot-life to allow ample time for application to the films, yet they develop acceptable bond strength properties within 5 days storage at ambient conditions as defined herein. After seven days cure at ambient conditions, the films prepared from the adhesives were elastomeric with tensile strength at break ranging from 1550 psi to 2993 psi and elongation at break ranging from 34% to 1035%.

In contrast, Comparative Example 1, which is representative of the current state of the art for aliphatic polyisocyanate based flexible packaging laminating adhesives, does not develop a measurable adhesive bond strength within 5 days storage and a film prepared from the adhesive itself has no elastomeric properties, even after seven days storage at ambient conditions (it was too soft to measure tensile and elongation with an INSTRON). Even after 20 days storage, Comparative Example 1 had a tensile strength of only 5 psi, indicative of the very slow cure speed compared with the adhesives of the invention.

Comparative Example 2 employs DIASPARTATE A (which is not an aspartate-terminated prepolymer of the invention) with POLYISOCYANATE B. This Example did not have suitable adhesive properties as evidenced by the low adhesive bond strengths and low elongation at break (9%) in tensile testing of the elastomeric material.

TABLE XIV

| | | Time for bond strength | |
|---|---|---|---|
| | | to reach a minimum of | |
| | Time to double in | 150 g/in. or substrate | |
| | viscosity @ 23° C. | tear@ 23° C. | |
| Ex. | (hours) | (days) | Comments |
| C1 | 16 | 7 | Current flexible packaging industry standard. |
| C2 | 1.2 | | Did not reach the minimum bond strength standard as defined. |
| 3 | 2 | — | Did not reach the minimum bond strength standard as defined. |
| 4 | 2.9 | 0.17 | Achieved the minimum bond strength and pot-life threshold as defined. |
| 5 | 1.1 | 0.17 | Achieved the minimum bond strength and pot-life threshold as defined. |
| 6 | 2 | 0.17 | Achieved the minimum bond strength and pot-life threshold as defined. |
| 7 | 0.5 | 0.17 | Achieved the minimum bond strength and pot-life threshold as defined. |
| 8 | 2 | 0.17 | Achieved the minimum bond strength and pot-life threshold as defined. |
| 9 | 1.8 | 0.17 | Achieved the minimum bond strength and pot-life threshold as defined. |
| 10 | 24 | 0.17 | Achieved the minimum bond strength and pot-life threshold as defined. |
| 11 | 8.5 | 0.17 | Achieved the minimum bond strength and pot-life threshold as defined. |
| 12 | 4 | 0.17 | Achieved the minimum bond strength and pot-life threshold as defined. |
| 13 | 2 | — | Did not reach the minimum bond strength standard as defined. |

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserves the right to amend the claims during prosecution to add features as variously described in this specification, and such amendments comply with the requirements of 35 U.S.C. § 112(a), and 35 U.S.C. § 132(a).

Various aspects of the subject matter described herein are set out in the following numbered clauses:

Clause 1. An adhesive comprising: (A) an aliphatic polyisocyanate; and (B) an aspartate-terminated prepolymer which is a reaction product of (B1) an aliphatic NCO-terminated prepolymer having a NCO content of from 0.5% to 35%, and (B2) a compound according to formula (I)

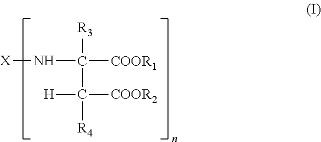

wherein, X represents a linear or branched aliphatic group obtained by removing amino groups from a linear or branched aliphatic polyamine, R₁ and R₂ are identical or different and represent organic groups which are inert towards isocyanate groups at a temperature of 100° C. or less, R₃ and R₄ are identical or different and represent hydrogen or organic groups which are inert towards isocyanate groups at a temperature of 100° C. or less, n represents an integer with a value of at least 2, wherein the aspartate-terminated prepolymer (B) has a ratio of equivalents of NH groups to equivalents of NCO groups of 1.5:1 to 20:1, (C) optionally, a solvent, wherein the adhesive has a ratio of equivalents of NCO groups in the aliphatic polyisocyanate to equivalents of NH groups of from 0.9:1 to 1.75:1, wherein pot life of the adhesive, as measured by doubling of viscosity according to ASTM D4212-16 at 23° C., is greater than or equal to 0.5 hours. and wherein the adhesive develops an acceptable bond strength to a substrate, defined as having a minimum of 150 g/in. measured @ 23° C. according to ASTM D 1876-01 or substrate tear, in less than or equal to 5 days after the substrate is laminated with the adhesive.

Clause 2. The adhesive according to Clause 1, wherein the aliphatic polyisocyanate (A) is selected from the group consisting of 1,4-tetramethylene diisocyanate, 1,5-pentamethylene diisocyanate (PDI), 1,6-hexamethylene diisocyanate (HDI), 2,2,4-trimethyl-hexamethylene diisocyanate, dodecamethylene diisocyanate, 2-methyl-L5-diisocyanatopentane, 1,4-diisocyanatocyclohexane, 1-isocyanato-3,3,5-trimethyl-5-isocyanato-methylcyclohexane (IPDI), 2,4-diisocyanato-dicyclohexyl-methane, 4,4′-diisocyanato-dicyclohexyl-methane, 1,3-bis (isocyanatomethyl)-cyclohexane, 1,4-bis (isocyanatomethyl)-cyclohexane, 1-isocyanato-1-methyl-3(4)-isocyanatomethyl-cyclohexane (IMCI), bis(4-isocyanato-3-methyl-cyclohexyl)-methane, 1,4-cyclohexane diisocyanate (CHDI), trimers, isocyanurates, uretdiones, biurets, allophanates, iminooxadiazine diones, carbodiimides, oxadiazine triones, and prepolymers of any of these, and mixtures thereof.

Clause 3. The adhesive according to one of Clauses 1 and 2, wherein the aliphatic NCO-terminated prepolymer (B1) comprises an aliphatic polyisocyanate selected from the group consisting of 1,4-tetramethylene diisocyanate, 1,5-pentamethylene diisocyanate (PDI), 1,6-hexamethylene diisocyanate (HDI), 2,2,4-trimethyl-hexamethylene diisocyanate, dodecamethylene diisocyanate, 2-methyl-1,5-diisocyanatopentane, 1,4-diisocyanatocyclohexane, 1-isocyanato-3,3,5-trimethyl-5-isocyanato-methylcyclohexane (IPDI), 2,4-diisocyanato-dicyclohexyl-methane, 4,4′-diisocyanato-dicyclohexyl-methane, 1,3-bis (isocyanatomethyl)-cyclohexane, 1,4-bis (isocyanatomethyl)-cyclohexane, 1-isocyanato-1-methyl-3(4)-isocyanatomethyl-cyclohexane (IMCI), bis(4-isocyanato-3-methyl-cyclohexyl)-methane, 1,4-cyclohexane diisocyanate (CHDI), trimers, isocyanurates, uretdiones, biurets, allophanates, iminooxadiazine diones, carbodiimides, oxadiazine triones, and prepolymers of any of these, and mixtures thereof.

Clause 4. The adhesive according to any one of Clauses 1 to 3, wherein the ratio of equivalents of NCO groups in the aliphatic polyisocyanate to NH groups in the aspartate terminated prepolymer in the adhesive is from 0.9:1 to 1.75:1.

Clause 5. The adhesive according to any one of Clauses 1 to 4, wherein X represents a group obtained by removing the amino groups from 1,4-diaminobutane, 1,6-diaminohexane, 2-methyl-1,5-pentane diamine, 2,2,4- and 2,4,4-trimethyl-1,6-diamino-hexane, 1,3-cyclohexane diamine, 1,4-cyclohexane diamine, 1-amino-3,3,5-trimethyl-5-aminomethyl-cyclohexane, 2,4-hexahydrotoluylene diamine, 2,6-hexahydrotoluylene diamine, 4,4′-diamino-dicyclohexyl methane, 3,3-dimethyl-4,4′-diamino-dicyclohexyl-methane, and 3,3-diethyl-4,4′-diamino-dicyclohexyl methane.

Clause 6. The adhesive according to any one of Clauses 1 to 5, wherein R₁ and R₂ represent a methyl, ethyl, propyl, or butyl group, wherein R₃ and R₄ represent hydrogen, and wherein n is 2.

Clause 7. The adhesive according to any one of Clauses 1 to 6, wherein pot-life, as measured by doubling of viscosity according to ASTM D4212-16 at 23° C., is greater than or equal to 2 hours.

Clause 8. The adhesive according to any one of Clauses 1 to 6, wherein pot-life, as measured by doubling of viscosity according to ASTM D4212-16 at 23° C., is greater than or equal to 4 hours.

Clause 9. The adhesive according to any one of Clauses 1 to 6, wherein pot-life, as measured by doubling of viscosity according to ASTM D4212-16 at 23° C., is greater than or equal to 7 hours.

Clause 10. The adhesive according to any one of Clauses 1 to 9, wherein the adhesive is cured.

Clause 11. The adhesive according to Clause 10, wherein the adhesive after curing has an elongation at break of from 30% to 2000% measured according to ASTM D 412.

Clause 12. A process comprising reacting and curing the adhesive according to any one of Clauses 1 to 11.

Clause 13. A multi-layered laminated film comprising a layer of the adhesive according to one of Clauses 1 to 11 applied to one or more substrate layers, wherein the adhesive layer after curing has an elongation at break of from 30% to 2000% measured according to ASTM D 412.

Clause 14. The multi-layered laminated film according to Clause 12, wherein the one or more substrate layers are independently selected from the group consisting of paper, metal and thermoplastic polymers.

Clause 15. The multi-layered laminated film according to Clause 14, wherein the thermoplastic polymers are independently selected from the group consisting of polyethylene, polyethylene terephthalate, corona-treated polyethylene terephthalate, metalized polyethylene terephthalate, and corona-treated polypropylene,

Clause 16. The multi-layered laminated film according to Clause 14, wherein the metal is selected from the group consisting of aluminum, copper, and steel.

Clause 17. A flexible packaging material comprising the multi-layered laminated film according to any one of Clause 13 to 16.

Clause 18. A process of minimizing aromatic amine migration in a packaging material, the process comprising: applying the adhesive according to one of Clauses 1 to 11 to a packaging material substrate, and curing the adhesive.

Clause 19. The process according to Clause 18, wherein the packaging material substrate comprises one or more layers selected from the group consisting of paper, metal and thermoplastic polymers.

Clause 20. The process according to one of Clause 19, wherein the thermoplastic polymers are independently selected from the group consisting of polyethylene, polyethylene terephthalate, corona-treated polyethylene terephthalate, metalized polyethylene terephthalate, and corona-treated polypropylene.

1. An adhesive comprising:
(A) an aliphatic polyisocyanate; and
(B) an aspartate-terminated prepolymer which is a reaction product of
(B1) an aliphatic NCO-terminated prepolymer having a NCO content of from 0.5% to 35%, and
(B2) a compound according to formula (I) 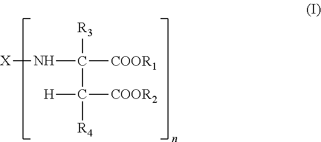
wherein,
X represents a linear or branched aliphatic group obtained by removing amino groups from a linear or branched aliphatic polyamine,
R₁ and R₂ are identical or different and represent organic groups which are inert towards isocyanate groups at a temperature of 100° C. or less,
R₃ and R₄ are identical or different and represent hydrogen or organic groups which are inert towards isocyanate groups at a temperature of 100° C. or less, n represents an integer with a value of at least 2,
wherein the aspartate-terminated prepolymer (B) has a ratio of equivalents of NH groups to equivalents of NCO groups of 1.5:1 to 20:1,
(C) optionally, a solvent,
wherein the adhesive has a ratio of equivalents of NCO groups in the aliphatic polyisocyanate to equivalents of NH groups of from 0.9:1 to 1.75:1,
wherein pot life of the adhesive, as measured by doubling of viscosity according to ASTM D4212-16 at 23° C., is greater than or equal to 0.5 hours, and
wherein the adhesive develops an acceptable bond strength to a substrate, defined as having a minimum of 150 g/in. measured @ 23° C. according to ASTM D 1876-01 or substrate tear, in less than or equal to 5 days after the substrate is laminated with the adhesive.

2. The adhesive according to claim 1, wherein the aliphatic polyisocyanate (A) is selected from the group consisting of 1,4-tetramethylene diisocyanate, 1,5-pentamethylene diisocyanate, 1,6-hexamethylene diisocyanate, 2,2,4-trimethyl-hexamethylene diisocyanate, dodecamethylene diisocyanate, 2-methyl-1,5-diisocyanatopentane, 1,4-diisocyanatocyclohexane, 1-isocyanato-3,3,5-trimethyl-5-isocyanato-methylcyclohexane, 2,4-diisocyanato-dicyclohexyl-methane, 4,4′-diisocyanato-dicyclohexyl-methane, 1,3-bis (isocyanatomethyl)-cyclohexane, 1,4-bis (isocyanatomethyl)-cyclohexane, 1-isocyanato-1-methyl-3(4)-isocyanatomethyl-cyclohexane, bis(4-isocyanato-3-methyl-cyclohexyl)-methane, 1,4-cyclohexane diisocyanate, trimers, isocyanurates, uretdiones, biurets, allophanates, iminooxadiazine diones, carbodiimides, oxadiazine triones, and prepolymers of any of these, and mixtures thereof.

3. The adhesive according to claim 1, wherein the aliphatic NCO-terminated prepolymer (B1) comprises an aliphatic polyisocyanate selected from the group consisting of 1,4-tetramethylene diisocyanate, 1,5-pentamethylene diisocyanate, 1,6-hexamethylene diisocyanate, 2,2,4-trimethyl-hexamethylene diisocyanate, dodecamethylene diisocyanate, 2-methyl-1,5-diisocyanatopentane, 1,4-diisocyanatocyclohexane, 1-isocyanato-3,3,5-trimethyl-5-isocyanato-methylcyclohexane, 2,4-diisocyanato-dicyclohexyl-methane, 4,4′-diisocyanato-dicyclohexyl-methane, 1,3-bis (isocyanatomethyl)-cyclohexane, 1,4-bis (isocyanatomethyl)-cyclohexane, 1-isocyanato-1-methyl-3(4)-isocyanatomethyl-cyclohexane, bis(4-isocyanato-3-methyl-cyclohexyl)-methane, 1,4-cyclohexane diisocyanate, trimers, isocyanurates, uretdiones, biurets, allophanates, iminooxadiazine diones, carbodiimides, oxadiazine triones, and prepolymers of any of these, and mixtures thereof.

4. The adhesive according to claim 1, wherein the ratio of equivalents of NCO groups in the aliphatic polyisocyanate to NH groups in the aspartate terminated prepolymer in the adhesive is from 0.9:1 to 1.75:1.

5. The adhesive according to claim 1, wherein X represents a group obtained by removing the amino groups from 1,4-diaminobutane, 1,6-diaminohexane, 2-methyl-L5-pentane diamine, 2,2,4-trimethyl-1,6-diamino-hexane, 2,4,4-trimethyl-1,6-diamino-hexane, 1,3-cyclohexane diamine, 1,4-cyclohexane diamine, 1-amino-3,3,5-trimethyl-5-aminomethyl-cyclohexane, 2,4-hexahydrotoluylene diamine, 2,6-hexahydrotoluylene diamine, 4,4′-diamino-dicyclohexyl methane, 3,3-dimethyl-4,4′-diamino-dicyclohexyl-methane and 3,3-diethyl-4,4′-diamino-dicyclohexyl methane.

6. The adhesive according to claim 1, wherein R₁ and R₂ represent a methyl, ethyl, propyl, or butyl group, wherein R₃ and R₄ represent hydrogen, and wherein n is 2.

7. The adhesive according to claim 1, wherein pot-life, as measured by doubling of viscosity according to ASTM D4212-16 at 23° C., is greater than or equal to 2 hours.

8. The adhesive according to claim 1, wherein pot-life, as measured by doubling of viscosity according to ASTM D4212-16 at 23° C., is greater than or equal to 4 hours.

9. The adhesive according to claim 1, wherein pot-life, as measured by doubling of viscosity according to ASTM D4212-16 at 23° C., is greater than or equal to 7 hours.

10. The adhesive according to claim 1, wherein the adhesive is cured.

11. The adhesive according to claim 10, wherein the adhesive has an elongation at break of from 30% to 2000% measured according to ASTM D 412.

12. A process comprising reacting and curing the adhesive according to claim 1.

13. A multi-layered laminated film comprising a layer of the adhesive according to claim 1 applied to one or more substrate layers, wherein adhesive layer after curing has an elongation at break of from 30% to 2000% measured according to ASTM D 412.

14. The multi-layered laminated film according to claim 13, wherein the one or more substrate layers are independently selected from the group consisting of paper, metal and thermoplastic polymers.

15. The multi-layered laminated film according to claim 14, wherein the thermoplastic polymers are independently selected from the group consisting of polyethylene, polyethylene terephthalate, corona-treated polyethylene terephthalate, metalized polyethylene terephthalate, and corona-treated polypropylene,

16. The multi-layered laminated film according to claim 14, wherein the metal is selected from the group consisting of aluminum, copper, and steel.

17. A flexible packaging material comprising the multi-layered laminated film according to claim 13.

18. A process of minimizing aromatic amine migration in a packaging material, the process comprising: applying the adhesive according to claim 1 to a packaging material substrate, and curing the adhesive.

19. The process according to claim 18, wherein the packaging material substrate comprises one or more layers selected from the group consisting of paper, metal and thermoplastic polymers.

20. The process according to one of claim 19, wherein the thermoplastic polymers are independently selected from the group consisting of polyethylene, polyethylene terephthalate, corona-treated polyethylene terephthalate, metalized polyethylene terephthalate, and corona-treated polypropylene.
